(19) United States
(12) Patent Application Publication
(10) Pub. No.: US 2026/0225348 A1
(43) Pub. Date: Aug. 6, 2026

(54) METAL FOAM PANELS AND RELATED MANUFACTURING METHODS

(71) Applicant: TransForm Automotive LLC, Sterling Heights, MI (US)

(72) Inventors: Bradley D. Holmes, Mount Brydges (CA); Brian M. Nosakowski, Macomb Township, MI (US)

(21) Appl. No.: 19/146,587

(22) PCT Filed: Jan. 26, 2024
(86) PCT No.: PCT/US2024/013174

§ 371 Date: Jul. 9, 2025

Related U.S. Application Data
(60) Provisional application No. 63/441,351, filed on Jan. 26, 2023.

(51) Int. Cl. B32B 15/04; B32B 3/18; B32B 5/18; B32B 15/01; B32B 15/20

(52) U.S. Cl. CPC B32B 15/046; B32B 3/18; B32B 5/18; B32B 15/01; B32B 15/20; B32B 2250/03; B32B 2266/045; B32B 2311/24

(57) ABSTRACT

A metal foam panel includes a first metal cover sheet, a second metal cover sheet, metal inserts coupled to insert locators of at least one of the first or second metal cover sheets, and a metal foam between the two metal cover sheets and surrounding corresponding portions of the metal inserts. Also disclosed is an in-process metal foam panel, and a related manufacturing method for the metal foam panel.

### TECHNICAL FIELD

This disclosure relates generally to panels and, more particularly, to metal foam panels and related methods of manufacturing same.

### BACKGROUND

Metal foam panels are useful in many applications, for instance, in buildings, aircraft, watercraft, rail cars, windmills, and motor vehicles. In a specific example, an aluminum foam panel replaces a traditional steel floor pan in battery electric vehicle (BEV) applications. Various applications for metal foam panels, such as rails, RESS (Rechargeable Energy Storage Systems), and seating, are reinforced with aluminum pucks to enhance compressive load support and prevent foam collapse. However, during the metal foaming process at high temperatures (approximately 600° C.), conventional methods of positioning the inserts between two cover sheets using 2-sided tape or TIG welding can fail. This failure allows the inserts to shift from their intended positions. Often, such dislocations of inserts are not detected until the final machining of the panel, leading to costly reworks or, in some cases, scrapping of the component due to these positional inaccuracies.

### BRIEF SUMMARY

An illustrative embodiment of a metal foam panel comprises a first metal cover sheet, a second metal cover sheet, metal inserts coupled to insert locators or projections of at least one of the first or second metal cover sheets, and a metal foam between the first and second metal cover sheets and surrounding corresponding portions of the metal inserts.

An illustrative embodiment of a method of manufacturing a metal foam panel includes providing a first metal cover sheet and a second metal cover sheet, coupling inserts to insert locators of at least one of the first or second metal cover sheets, and assembling a metal foam precursor over the first metal cover sheet. The method also includes assembling the second metal cover sheet over the first metal cover sheet to establish an in-process panel and a foaming space between the first and second metal cover sheets. The method further includes heating the in-process panel to foam the metal foam precursor into a metal foam between the first and second metal cover sheets and around the metal inserts.

### BRIEF DESCRIPTION OF THE DRAWINGS

FIG. 1 is a perspective view of a metal foam panel according to an illustrative embodiment of the present disclosure and including a first metal cover sheet, a second metal cover sheet, a plurality of inserts between the first and second metal cover sheets and coupled to at least one of the first or second metal cover sheets, and a metal foam between the first and second metal cover sheets and surrounding corresponding portions of the plurality of inserts.

FIG. 2 is an enlarged fragmentary perspective view of a portion of the metal foam panel illustrated in FIG. 1.

FIG. 3 is a fragmentary cross-sectional view of a metal foam panel having an insert locator in the form of a blind hole or pocket in at least one of the first or second metal cover sheets to couple an insert to the metal cover sheet(s), according to an illustrative embodiment of the present disclosure.

FIG. 4 is a fragmentary cross-sectional view of a metal foam panel having a 2-sided tape or adhesive to couple an insert to a metal cover sheet, according to the prior art.

FIG. 5 is a fragmentary cross-sectional view of a metal foam panel having a TIG weld to couple an insert to a metal cover sheet, according to the prior art.

FIG. 6 is a fragmentary cross-sectional view of a metal foam panel, according to an illustrative embodiment of the present disclosure.

FIG. 6A is a fragmentary cross-sectional view of an in-process metal foam panel having a first metal cover sheet, a second metal cover sheet, an insert between the first and second metal cover sheets, and a metal foam precursor between the first and second metal cover sheets, according to an illustrative embodiment of the present disclosure.

FIG. 7 is a fragmentary cross-sectional view of a metal foam panel, according to another illustrative embodiment of the present disclosure.

FIG. 8 is a fragmentary cross-sectional view of a metal foam panel, according to another illustrative embodiment of the present disclosure.

FIG. 9 is a fragmentary cross-sectional view of a metal foam panel, according to another illustrative embodiment of the present disclosure.

FIG. 10 is a fragmentary cross-sectional view of a metal foam panel, according to another illustrative embodiment of the present disclosure.

FIG. 11 is a fragmentary cross-sectional view of a metal foam panel, according to another illustrative embodiment of the present disclosure.

FIG. 12 is a fragmentary cross-sectional view of a metal foam panel, according to another illustrative embodiment of the present disclosure.

FIG. 13 is a fragmentary cross-sectional view of a metal foam panel, according to another illustrative embodiment of the present disclosure.

FIG. 14 is a fragmentary cross-sectional view of a metal foam panel, according to another illustrative embodiment of the present disclosure.

FIG. 15 is a fragmentary cross-sectional view of a metal foam panel, according to another illustrative embodiment of the present disclosure.

FIG. 16 is a fragmentary cross-sectional view of a metal foam panel, according to another illustrative embodiment of the present disclosure.

FIG. 17 is a fragmentary cross-sectional view of a metal foam panel, according to another illustrative embodiment of the present disclosure.

FIG. 18 is a fragmentary cross-sectional view of a metal foam panel, according to another illustrative embodiment of the present disclosure.

FIG. 19 is a fragmentary cross-sectional view of a metal foam panel, according to another illustrative embodiment of the present disclosure.

FIG. 20 is a fragmentary cross-sectional view of a metal foam panel, according to another illustrative embodiment of the present disclosure.

FIG. 21 is a fragmentary cross-sectional view of a metal foam panel, according to another illustrative embodiment of the present disclosure.

FIG. 22 is a fragmentary cross-sectional view of a metal foam panel, according to another illustrative embodiment of the present disclosure.

FIG. 23 is a fragmentary cross-sectional view of a metal foam panel, according to another illustrative embodiment of the present disclosure.

### DETAILED DESCRIPTION

In general, a metal foam panel will be described, using several examples of illustrative embodiments, that includes a first metal cover sheet, a second metal cover sheet, a plurality of metal inserts between the first and second metal cover sheets, and a metal foam between the first and second metal cover sheets and surrounding corresponding portions of the plurality of metal inserts. The metal inserts may enhance compressive load support and prevent foam collapse, particularly for battery electric vehicle applications. However, it will be appreciated as the description proceeds that the invention is useful in many different applications and may be implemented in many other embodiments. In this regard, and as used herein and in the claims, it will be understood that metal foam panels are not limited solely to the automotive sector but can also find utility in construction, aviation, marine vessels, railway cars, wind energy installations, and other types of motor vehicles. Furthermore, the size, shape, and/or configuration of the metal foam panel can vary depending on the specific circumstances and requirements.

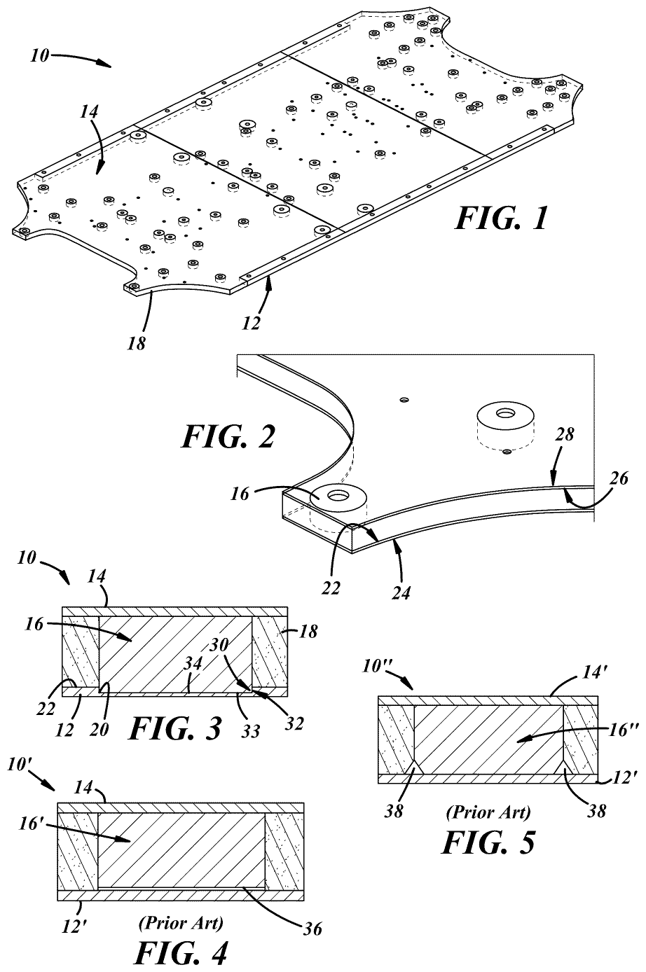

With reference now to FIGS. 1 and 2, and in contrast to a traditional steel floor pan, the presently disclosed foam metal panel 10 comprises a lower or first metal cover sheet 12, an upper or second metal cover sheet 14, a plurality of metal inserts 16 between the first and second metal cover sheets 12, 14, and a metal foam 18 between the first and second metal cover sheets 12, 14 and surrounding corresponding portions of the metal inserts 16. In one example, the metal foam may be a cellular structure including a solid metal with gas-filled pores comprising a relatively large portion of a volume of the metal foam. The inserts 16 may be provided in columns and rows, along edges of the panel 10, and in any suitable quantity and configuration. As will be described in more detail herein below, the metal foam 18 may be produced from a metal foam precursor. As used herein, the term “metal” includes elemental metal or metal alloy.

The material used for the metal cover sheets 12, 14, metal inserts 16, and metal foam precursor for the metal foam 18 can be any type of metal(s) or metal alloy(s). Additionally, the melting point of the first and second metal cover sheets should be higher than that of the metal foam precursor. The metal may be, for example, aluminum, but instead may be magnesium, steel, alloys of the aforementioned base metals, or any other metal(s) or metal alloy(s) suitable for producing a metal foam panel. The first and second metal cover sheets and/or inserts may be composed of 6XXX series aluminum with a higher melting point than that of the metal foam precursor. The metal foam precursor may include an aluminum or aluminum alloy with a melting point lower than that of the metal(s) or metal alloy(s) of the first and second metal cover sheets and/or inserts, and may include a foaming agent, for example, Titanium Hydride (TiH₂), and Silicon (Si). Extrusion, pressing, or other compacting processes may be used to make the metal foam precursor.

With continued reference to FIGS. 1 and 2, the first metal cover sheet 12 comprises a first or interior face 22 in contact with the metal foam 18, and an opposite second or exterior face 24 not in contact with the metal foam 18 and, likewise, the second metal cover sheet 14 comprises a first or interior face 26 in contact with the metal foam 18, and an opposite second or exterior face 28 not in contact with the metal foam 18. As an example frame of reference, the first and second metal cover sheets 12, 14 are spaced axially apart from one another, and the metal inserts 16 are spaced laterally apart from one another. The metal inserts 16 could be pucks, columns, spheres, or inserts of any other shape suitable for processing in accordance with the present disclosure.

With reference now to FIG. 3, the metal cover sheet is illustrated as including an insert locator 20 with a corresponding insert 16 coupled to the insert locator 20, such that the panel 10 may include a plurality of the insert locator 20 and a plurality of the insert 16 coupled to the plurality of the insert locator 20. The relationship between the metal inserts 16 and the insert locators 20 in the metal cover sheet 12 secures the metal inserts 16 with respect to the metal cover sheet 12, thereby curtailing unintended movement during a metal foaming process at elevated temperatures. The insert locators 20 may be features of one or both of the sheets 12, 14 that are unitary with the sheets 12, 14, and not separate components. The novelty of the relationship between the metal inserts 16 and the insert locators 20 may lend novelty to the panel 10 itself.

In the embodiment illustrated in FIG. 3, each insert locator 20 is configured into the interior face 22 of the metal cover sheet 12, and accommodates the corresponding insert 16 therein. The insert locator 20 includes a circumferential interior surface 30, and the insert 16 includes a corresponding circumferential exterior surface 32 circumscribed by the circumferential interior surface 30 of the respective insert locator 20. The insert locator 20 illustrated in FIG. 3 is a blind hole or pocket but, as illustrated in other drawing figures, could be a through hole, aperture, post, embossment, debossment, piercing, semi-piercing, circular ridge, circular groove, or any other feature suitable for coupling to a corresponding portion of the insert 16 to laterally restrain the insert 16 from moving relative to one or both of the metal sheets 12, 14. Accordingly, a lower or first surface 33 of the insert 16 is located against a corresponding base surface 34 of the locator 20. Although the metal inserts 16 are shown as being cylindrical, the metal inserts 16 may be of hexagonal, ovular, or any other suitable shape. Moreover, a diameter or similar feature of a lower or first end of the metal insert 16 may be of a size that corresponds to a corresponding diameter or similar feature of the insert locator 20 to ensure a coupling of the metal insert 16 to the insert locator 20 to laterally restrain the metal insert 16 relative to the insert locator 20 and the respective metal sheet(s) 12, 14. For example, the metal insert 16 and the insert locator 20 may be sized to provide an interference or press fit therebetween to curtail foam outflow during processing.

FIGS. 4 and 5 illustrate metal foam panels 10′, 10″ according to the prior art. FIG. 4 is a fragmentary cross-sectional view of a metal foam panel 10′ from the prior art, where a 2-sided tape or adhesive 36 is employed to couple metal inserts 16′ to one of first and second metal cover sheets 12′, 14′. FIG. 5 is a fragmentary cross-sectional view of a metal foam panel 10″ from the prior art, using TIG welding as the method to secure metal inserts 16″ to one of two metal cover sheets 12′, 14′. TIG welds 38 are provided on the outer bottom of the metal inserts 16″ to the metal cover sheet 12′. However, these traditional panels 10′, 10″, such as using 2-sided tape or TIG welding, can face challenges when subjected to the extreme temperatures (at least 600° C.) involved in a metal foaming process. Under these conditions, the conventional approaches may fail, resulting in the unintended shifting of metal inserts from their designated positions. Often, such insert displacements go undetected until the final machining of the panels 10′, 10″, leading to costly rework efforts or, in some instances, the need to discard the panels 10′, 10″ due to these positional inaccuracies.

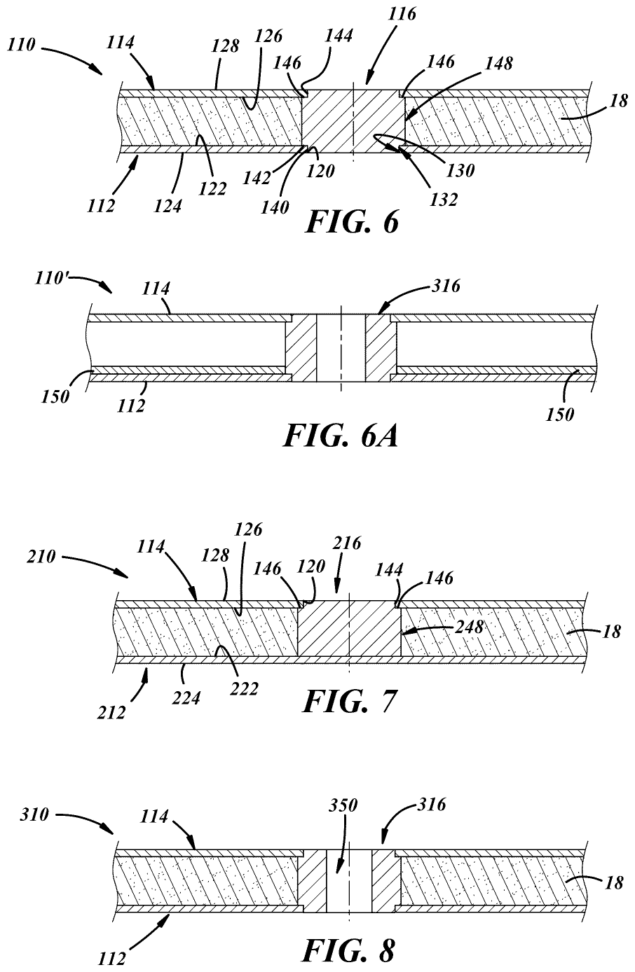

In an embodiment of the present disclosure illustrated in FIG. 6, a metal insert 116 deviates from the solid cylindrical shape shown in FIG. 3 in that it incorporates various features, including a lower or first neck 140, a lower or first shoulder 142, a body 148, an upper or second shoulder 146, and an upper or second neck 144. The insert 116 includes axially opposite ends that may couple to one or more corresponding insert locators 120 in a first metal cover sheet 112 and/or in a second metal cover sheet 114. The first metal cover sheet 112 is equipped with insert locators 120 in the form of apertures corresponding to the first necks 140 of the metal inserts 116, allowing the necks 140 to fit within these apertures. The insert locators 120 (e.g., voids) instead could be blind holes or pockets. Additionally, the insert locator 120 includes a cylindrical interior surface 130 and the insert 116 includes a cylindrical exterior surface 132 circumscribed by the cylindrical interior surface 130 of the respective insert locator 120. Each insert locator 120 is expressly designed to accommodate the first necks 140 of the metal inserts 116, ensuring a secure fit within these insert locators 120. The first shoulder 142 contacts an interior face 122 of the first metal cover sheet 112, while the second shoulder 146 contacts an interior face 126 of the second metal cover sheet 114. Moreover, the outer sidewall 148 of the insert body 148 is in contact with the metal foam 18.

With reference now to FIG. 6A, an in-process metal foam panel 110′ includes the first metal cover sheet 112, the second metal cover sheet 114, metal inserts 316 between the first and second metal cover sheets 112, 114, and a metal foam precursor 150 between the first and second metal cover sheets 112, 114. As illustrated, the metal foam precursor 150 could be in sheet form. But in other embodiments, it could be in the powder form, flat pieces or coupons form, pellet form, or in any other form suitable for foaming. The metal foam precursor 150 is shown located over the first metal cover sheet 112, which may be a lower cover sheet or may be an upper cover sheet. More specifically, the metal foam precursor 150 is shown in direct contact with the respective cover sheet, but may be spaced apart from the respective cover sheet.

In an embodiment presented in FIG. 7, a metal insert 216 includes an upper or second neck 144, a second shoulder 146, and a body 248. An upper or second metal cover sheet 114 is equipped with insert locators 120 in the form of apertures corresponding to the second necks 144 of the metal inserts 216, allowing the second necks 144 to fit within these apertures. The second shoulder 146 is in contact with the interior face 126 of the second metal cover sheet 114, and the outer sidewall of the insert body 248 is in contact with the metal foam 18. In this embodiment, the first metal cover sheet 212 does not include an insert locator 120. Instead, a first end of the insert rests against an interior face 222 of the first metal cover sheet 212, in which case, the insert locators 120 of the second metal cover sheet 114 serve to accurately locate the metal inserts 216.

The structural configuration of a panel 310 as depicted in FIG. 8 is consistent with that in FIG. 6, except for the presence of central cylindrical through holes 350 in the metal inserts 316.

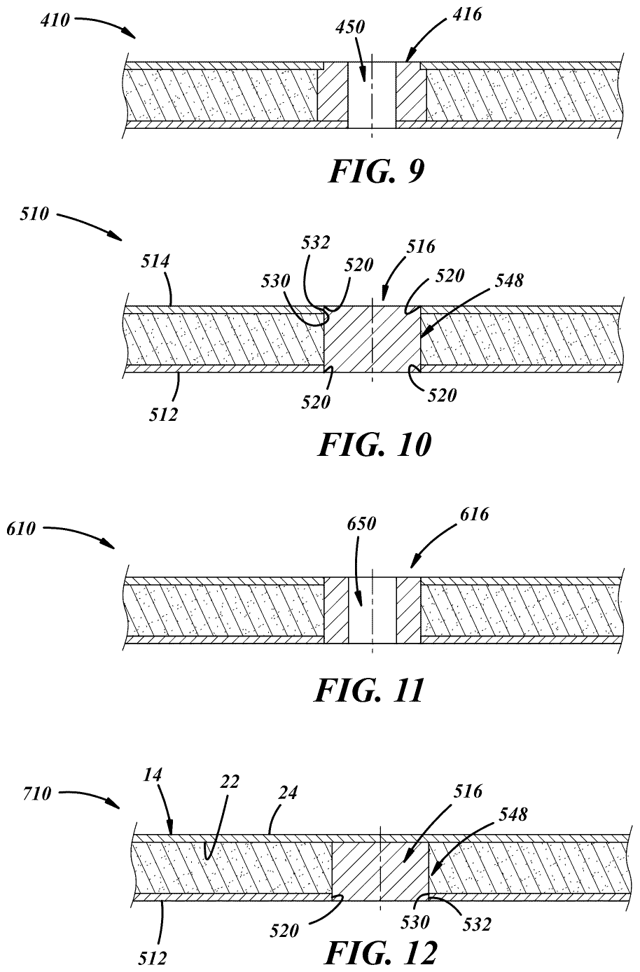

The structural configuration of a panel 410 as depicted in FIG. 9 is consistent with that in FIG. 7, except for the presence of central cylindrical through holes 450 in the metal inserts 416.

In an embodiment of a panel 510 illustrated in FIG. 10, a metal insert 516 takes on a solid cylindrical shape. Both metal cover sheets 512, 514 are equipped with insert locators 520. The first metal cover sheet 512 is equipped with insert locators 520 in the form of apertures that precisely match the bodies 548 of the metal inserts, allowing the metal inserts 516 to fit into these apertures. Additionally, the second metal cover sheet 514 contains multiple insert locators 520, each featuring a cylindrical interior surface 530. Each insert includes a cylindrical exterior surface 532 circumscribed by the cylindrical interior surface 530 of the respective insert locator 520. These insert locators 520 are explicitly designed to accommodate the bodies 548 of the metal inserts, ensuring a secure fit within these insert locators. Furthermore, the outer sidewall of the metal insert body is coupled to the metal foam. Alternatively, the insert locators in both metal cover sheets could be blind holes or pockets.

The structural configuration of a panel 610 as depicted in FIG. 11 is consistent with that in FIG. 10, except for the presence of central cylindrical through holes 650 in the metal inserts 616.

In an embodiment of a panel 710 illustrated in FIG. 12, a metal insert 516 takes on a solid cylindrical shape. A first metal cover sheet 512 contains multiple insert locators 520, each of which may feature a cylindrical interior surface. Each insert includes a cylindrical exterior surface 532 circumscribed by the cylindrical interior surface 530 of the respective insert locator 520. These insert locators 520 are explicitly designed to accommodate the bodies 548 of the metal inserts 516, ensuring a secure fit within these insert locators 520. Furthermore, top ends of the metal inserts 516 are engaged with the interior face 222 of the second metal cover sheet 212 and outer sidewall of the metal insert body 548 is coupled to the metal foam. Alternatively, the insert locators in the first metal cover sheet 512 could be blind holes or pockets.

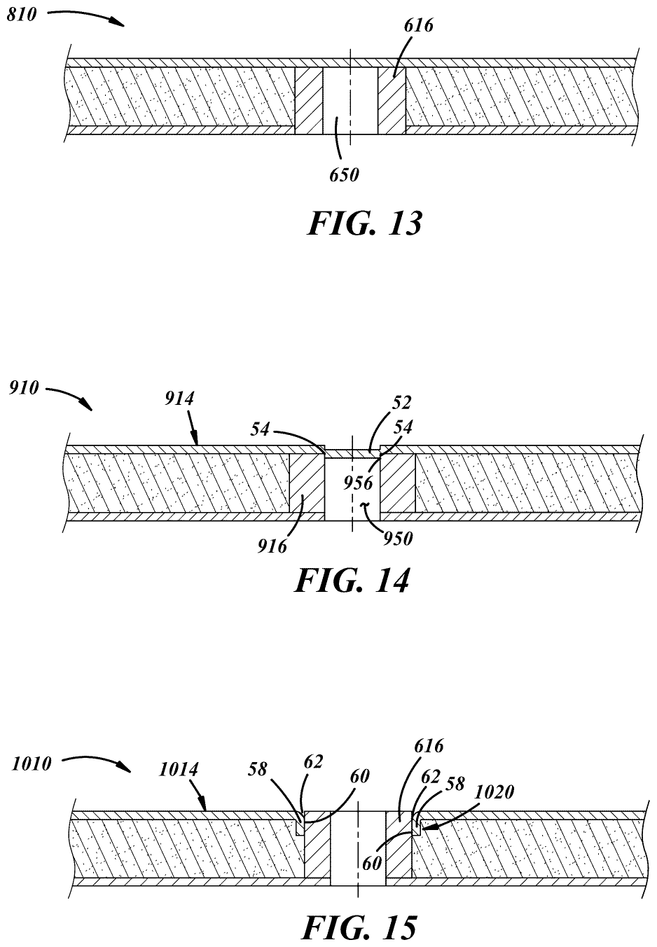

The structural configuration of a panel 810 as depicted in FIG. 13 is consistent with that in FIG. 12, except for the presence of central cylindrical through holes 650 in metal inserts 616.

In an embodiment of a panel 910 illustrated in FIG. 14, at least one metal cover sheet 914 contains multiple projections 52 in an interior direction, each projection 52 has a cylindrical exterior surface 54. Each metal insert 916 has central cylindrical voids 950 with cylindrical interior surfaces 56, circumscribing the cylindrical exterior surfaces 54 of the projections 52. The projections 52 are explicitly designed to be accommodated within the voids 950 in the metal inserts 916, ensuring a secure fit within these voids 950.

In an embodiment of a panel 1010 illustrated in FIG. 15, at least one metal cover sheet contains locators 1020 established by inwardly projecting annular lips 58 extending in an interior direction and having interior cylindrical surfaces 60. Each exterior cylindrical wall 62 of the metal inserts 616 is circumscribed by the interior cylindrical surface 60 of the locator 1020. The lips 58 are explicitly designed to accommodate the metal insert 616, ensuring a secure fit thereto.

In an embodiment illustrated in FIG. 16, a metal insert 1116 includes an insert neck 64, an insert shoulder 66, and an insert body 68. A second metal cover sheet 614 contains multiple insert locators 120, permitting the insert necks 64 to pass through and extend outward beyond the exterior face 74 of the second metal cover sheet 614. An outer sidewall of the neck 64 is circumscribed by an interior surface of the locator 120. The insert shoulder 66 is in contact with an interior face 72 of the second metal cover sheet 614, and the outer sidewall of insert body 68 is contact with the metal foam 18. In this embodiment, the first metal cover sheet 212 does not include an insert locator. Instead, a first end of the insert 1116 rests against an interior face 222 of the first metal cover sheet 212, in which case, the insert locators 120 of the second metal cover sheet 614 serve to accurately locate the metal inserts 1116.

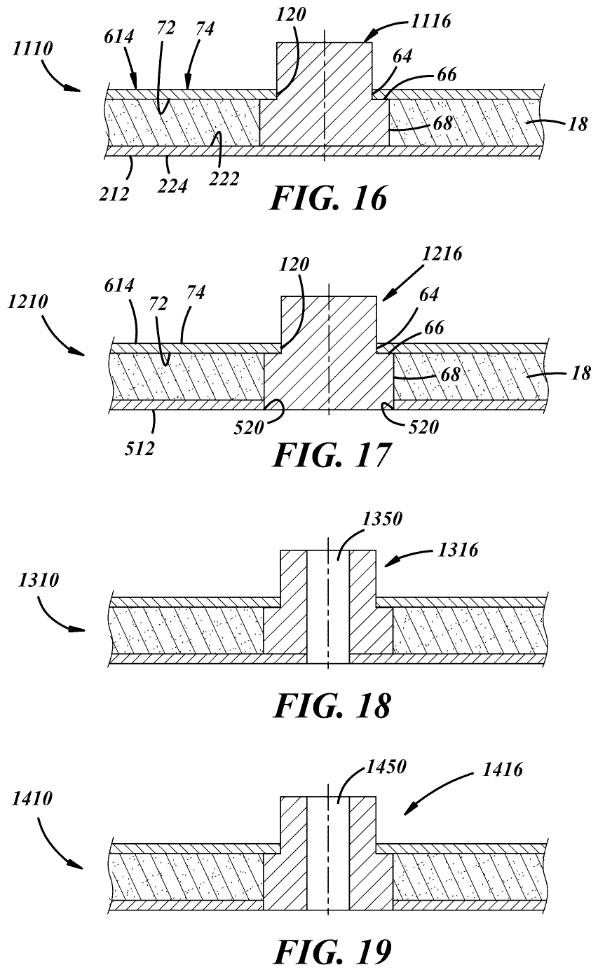

In an embodiment of a panel 1210 illustrated in FIG. 17, a metal insert includes an insert neck 64, an insert shoulder 66, and an insert body 68. A second metal cover sheet 614 includes insert locators 120 permitting the insert necks 64 to pass through and extend outward beyond an exterior face 74 of the second metal cover sheet 614. An outer sidewall of the neck 64 is circumscribed by an interior surface of the locator 120. The insert shoulder 66 is in contact with an interior face 72 of the second metal cover sheet 614, and the outer sidewall of insert body 68 is contact with the metal foam 18. Additionally, the first metal cover sheet 512 contains multiple insert locators 520, each featuring a cylindrical interior surface. Each insert includes a cylindrical exterior surface circumscribed by the cylindrical interior surface of the respective insert locator 520. These insert locators 520 are explicitly designed to accommodate the bodies 68 of the metal inserts 916, ensuring a secure fit within these insert locators 520.

The structural configuration of a panel 1310 as depicted in FIG. 18 is consistent with that in FIG. 16, except for the presence of central cylindrical through holes 1350 in the metal inserts 1316.

The structural configuration of a panel 1410 as depicted in FIG. 19 is consistent with that in FIG. 17, except for the presence of central cylindrical through holes 1450 in the metal inserts 1416.

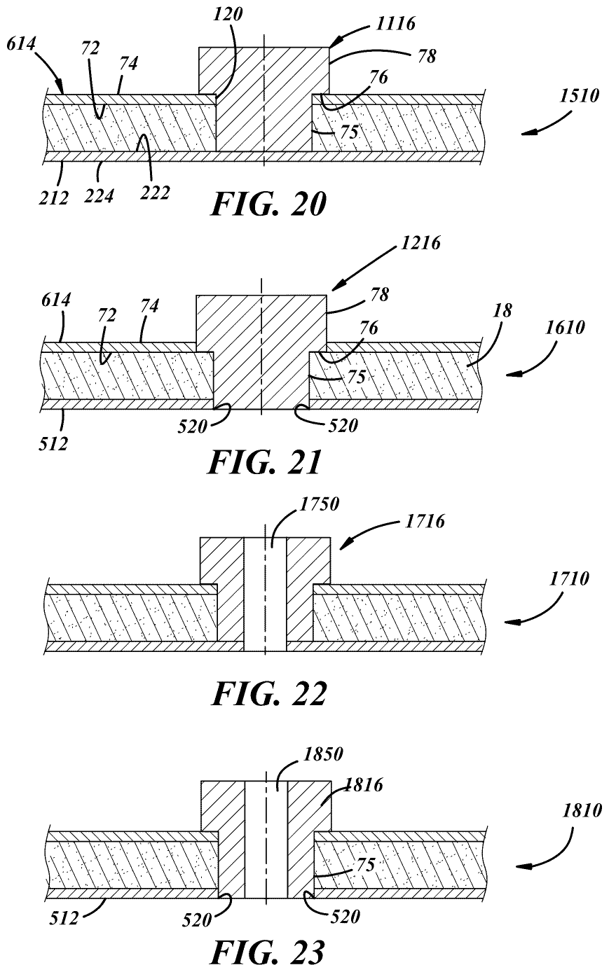

The structural configuration of a panel 1510 as depicted in FIG. 20 is consistent with that in FIG. 16, except the metal insert 1116 is inserted into the panel 1510 in a reversed orientation. A metal insert 1116 includes an insert neck 75, an insert shoulder 76, and an insert body 78. The second metal cover sheet 614 contains multiple locators 120, permitting the insert necks 74 to pass therethrough and the insert bodies 78 to extend outward beyond the exterior face 74 of the second metal cover sheet 614. The outer sidewall of the neck 75 is circumscribed by the interior surface of the locator 120. The insert shoulder 76 is in contact with the exterior face 74 of the second metal cover sheet 614, and the outer sidewall of the insert neck 75 is contact with the metal foam 18. In this embodiment, the first metal cover sheet 212 may not include an insert locator. Instead, a first end of the insert 1116 rests against an interior face 222 of the first metal cover sheet 212, in which case, the insert locators 120 of the second metal cover sheet 614 serve to accurately locate the metal inserts 1116.

With reference to a panel 1610 of FIG. 21, a metal insert 1216 includes an insert neck 75, an insert shoulder 76, and an insert body 78 and a second metal cover sheet 614 includes locators 120, permitting the insert bodies 78 to pass through and extend outward beyond the exterior face 74 of the second metal cover sheet 614. The outer sidewall of the body 78 is circumscribed by the interior surface of the locator 120. The insert shoulder 76 and the outer sidewall of the insert neck 75 are contact with the metal foam 18. Additionally, the first metal cover sheet 512 contains multiple insert locators 520, each featuring a cylindrical interior surface. Each insert 1216 includes a cylindrical exterior surface circumscribed by the cylindrical interior surface of the respective insert locator 520. These insert locators 520 are explicitly designed to accommodate the bodies of the metal inserts 1216, ensuring a secure fit within these insert locators 520.

The structural configuration of a panel 1710 as depicted in FIG. 22 is consistent with that in FIG. 20, except for the presence of central cylindrical through holes 1750 in the metal inserts 1716.

The structural configuration of a panel 1810 as depicted in FIG. 23 is similar to that in FIG. 22, except for the presence of first insert locators 520 in the first metal cover sheet 512 wherein insert necks 1874 of the metal inserts 1816 may fit within the locators 520.

At least one of metal cover sheets may include insert locators corresponding in shape and size to the metal inserts, ensuring each insert couples securely to its respective insert locator. The insert locators in at least one of the first or second metal cover sheets could be through holes, apertures, posts, embossments, debossments, piercings, semi-piercings, circular ridges, circular grooves, or any other features suitable for coupling the inserts to the sheets and, in any event, may be provided in any suitable sizes, shapes, and configurations to match corresponding sizes, shapes, and configurations of the corresponding metal inserts. Additionally, the various features and configurations illustrated in FIGS. 3 and 6-23 may be combined in any suitable manner to produce additional embodiments encompassed by the present disclosure and the claims and, for expedience, not every combination is illustrated.

From the above, those of ordinary skill in the art would recognize that the various panels may be structural foam composite products, wherein structural aluminum foam may be metallurgically bonded to and sandwiched between cover sheets and reinforced with inserts. Bonding may be achieved by heating the metal foam precursor above the solidus temperature of its base alloy thereby causing partial melting while an incorporated blowing agent, for example TiH2, decomposes, giving off a gas, and creates gas-filled voids within the semi-molten precursor. Continued heating results in continued gas evolution, increased pressure, expansion, and formation of the metal foam. The physical contact created by the expanding foam with the metal cover sheets and the metal inserts, at the elevated temperatures drives a diffusion process that allows the metal cover sheets and the metal inserts to draw Si from the semi-molten precursor due to a concentration gradient which lowers the melting temperature of the metal sheets and the metal inserts and causes the metal sheets and the metal inserts to fuse to the semi-molten precursor/foam. Upon cooling, the metal cover sheets, metal inserts, and solidified metal foam become unitary.

Bonding dissimilar metals, for example aluminum foam and steel cover sheets and/or steel inserts, occurs in much the same way, but the high temperature interaction of the foam and the dissimilar steel cover sheets and/or inserts is different. Localized melting of the steel cover sheets and/or inserts may not occur and, instead, the steel cover sheets and/or inserts bonds with the molten or semi-molten foam as a result of the foam dissolving into, and alloying with, surfaces of the steel cover sheets and/or inserts and forming bonding layers between the foam and the steel cover sheets and/or inserts.

Manufacturing of the metal foam panel may be carried out in a closeable mold. The manufacturing process includes provision of a metal cover sheet, which may be machined, formed, or otherwise processed to include insert locators corresponding to the metal inserts. These insert locators accommodate and secure inserts at least during the manufacturing process. The closeable mold may be sprayed or otherwise processed with a release agent and then the first metal cover sheet may be located in the mold. The metal inserts are coupled to the insert locators of one or both of the first and second metal cover sheets. For example, in some embodiments, the metal inserts may be interference fit to pre-existing corresponding voids, protrusions, or other features of one or both of the metal sheets. In other embodiments, the metal inserts and/or one or both of the metal sheets may be pressed into contact with one another to fully pierce, partially pierce, or otherwise deform one or both of the metal sheets to form the insert locators. The metal inserts and the insert locators may be sized to facilitate coupling the inserts to the locators according to an interference or press fit therebetween to curtail foam outflow during processing.

A metal foam precursor is applied between the first and second metal cover sheets, for example, applied over the first metal cover sheet, more specifically, onto the interior surface of the first metal cover sheet. The metal foam precursor material may be in the form of a sheet with cutouts, granulated bulk material, or small pieces of sheet or coupons laid on the first metal cover sheet. This precursor material sets the stage for the formation of the metal foam that will provide the panel with structural integrity or at least enhance its structural integrity, and may also provide acoustic and/or thermal insulation. It may be desirable to control the density of the metal foam precursor metal at 95% or greater, providing greater resistance to damage during the manufacturing process of the metal foam panel. This may be accomplished by compacting, rolling, or any other precursor metal densification techniques.

The second metal cover sheet is then assembled over the first metal cover sheet, for example, onto the metal inserts, to establish an in-process panel and a foaming space between the first and second metal cover sheets. The second metal cover sheet also may be machined, formed, or otherwise processed to include insert locators that correspond to the metal inserts. The mold may be closed to clamp the metal sheets together and then may be moved into a furnace to heat the in-process panel to produce the metal foam. A furnace temperature of at least 600° C. may be used to facilitate the metal foaming process, resulting in metal foam that is securely bound between the two metal cover sheets and around the metal inserts. The panel is then removed from the furnace and allowed to cool to complete the process.

Even during the metal foaming process at high temperatures, lateral location of the metal inserts is controlled to maintain a true position within a tolerance of less than 1 mm, for example, less than 0.7 mm. Additionally, the method may include features such as the incorporation of locating shoulders on the metal inserts, or locating features on the metal inserts that are used to form corresponding pierce or semi-pierce sections in the metal cover sheet, which aid in precisely positioning the metal inserts relative to the first and second metal cover sheets and maintaining desired spacing between the first and second metal cover sheets. In any event, the method ensures that the final panel meets tight tolerances, with insert locations controllable to less than 0.7 mm true position after the clamping and heating step. The method for manufacturing metal foam panels provides a precise and reliable means of creating lightweight, high-strength panels suitable for a wide range of applications.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed embodiment, element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A metal foam panel, comprising:
a first metal cover sheet;
a second metal cover sheet;
metal inserts coupled to insert locators of at least one of the first or second metal cover sheets; and
a metal foam between the first and second metal cover sheets and surrounding corresponding portions of the metal inserts.

2. The metal foam panel of claim 1, wherein the metal inserts include cylindrical pucks.

3. The metal foam panel of claim 1, wherein the metal inserts form corresponding fully pierced or semi-pierced insert locators in one or both of the first and second metal cover sheets.

4. The metal foam panel of claim 1, wherein the first metal cover sheet includes an interior face in contact with the metal foam and an opposite exterior face not in contact with the metal foam, and wherein the second metal cover sheet includes an interior face in contact with the metal foam and an opposite exterior face not in contact with the metal foam.

5. The metal foam panel of claim 1, wherein the insert locators include cylindrical interior surfaces and the metal inserts include cylindrical exterior surfaces circumscribed by the cylindrical interior surfaces.

6. The metal foam panel of claim 1, wherein the panel does not include any tape or adhesive to couple the metal inserts to either of the first and second metal cover sheets.

7. The metal foam panel of claim 1, wherein the panel does not include TIG welds to couple the metal inserts to either of the first and second metal cover sheets.

8. The metal foam panel of claim 1, wherein at least one of the first or second metal cover sheets includes the insert locators in the form of blind holes or pockets.

9. An in-process metal foam panel, comprising:
a first metal cover sheet;
a second metal cover sheet;
metal inserts coupled to insert locators of at least one of the first or second metal cover sheets; and
a foam precursor between the first and second metal cover sheets.

10. The in-process metal foam panel of claim 9, wherein at least one of the first or second metal cover sheets includes the insert locators in the form of apertures through at least one of the first or second metal cover sheets.

11. The in-process metal foam panel of claim 10, wherein the first metal cover sheet includes some of the insert locators and the second metal cover sheet includes some of the insert locators, and the metal inserts include axially opposite ends that couple to the insert locators in the first and second metal cover sheets.

12. The in-process metal foam panel of claim 10, wherein the metal inserts include first necks accommodated within insert locators of the first metal cover sheet, first shoulders, insert bodies, second shoulders, and second necks accommodated within insert locators of the second metal cover sheet.

13. The in-process metal foam panel of claim 10, wherein the metal inserts include first necks, first shoulders, and insert bodies, and at least one of the first or second metal cover sheets includes insert locators corresponding to the first necks of the metal inserts, with the first necks being accommodated within the insert locators.

14. The in-process metal foam panel of claim 10, wherein the metal inserts have bodies and first ends of the bodies are accommodated within the insert locators of at least one of the first or second metal cover sheets.

15. The in-process metal foam panel of claim 10, wherein the metal inserts have insert bodies, and both cover sheets have the insert locators accommodating first and second ends of the insert bodies.

16. The in-process metal foam panel of claim 10, wherein the metal inserts have central cylindrical through holes.

17. A method of manufacturing a metal foam panel, comprising:
providing a first metal cover sheet and a second metal cover sheet;
coupling metal inserts to insert locators of at least one of the first or second metal cover sheets;
applying a metal foam precursor over the first metal cover sheet;
assembling the second metal cover sheet over the first metal cover sheet to establish an in-process panel and a foaming space between the first and second metal cover sheets; and
heating the in-process panel to foam the metal foam precursor into a metal foam between the first and second metal cover sheets and around the metal inserts.

18. The method of claim 17, wherein the insert locators maintain lateral position of the metal inserts with respect to one or both of the first and second metal cover sheets during the heating step.

19. The method of claim 17, wherein the heating step includes heating to a furnace temperature of at least 600° C.

20. The method of claim 17, wherein the first and second metal cover sheets have a higher melting point than the metal foam precursor and inserts.
